(19) United States
(12) Patent Application Publication
(10) Pub. No.: US 2012/0312136 A1
(43) Pub. Date: Dec. 13, 2012

(54) METHOD OF SLICING PRODUCTS

(75) Inventors: Sergej Garaew, Siegen (DE); Kai Andre Briel, Wallau (DE)

(73) Assignee: Weber Maschinenbau GmbH Breidenbach, Breidenbach (DE)

(21) Appl. No.: 13/490,597

(22) Filed: Jun. 7, 2012

(30) Foreign Application Priority Data
Jun. 9, 2011 (DE) 102011103863.2

(51) Int. Cl. B26D 1/00; B26D 7/06

(52) U.S. Cl. 83/13; 83/401

(57) ABSTRACT

In a method of slicing products, a plurality of products are fed simultaneously on parallel conveying tracks to a cutting plane in which at least one cutting blade moves, in particular in a rotating and/or revolving manner. A number of produces exceeding the number of conveying tracks is provided, at least one product parameter is determined for each provided product, a set of products corresponding to the number of conveying tracks is selected from the provided products and the selected set of products is fed to the cutting plane on the conveying tracks.

### CROSS-REFERENCE TO RELATED APPLICATIONS

This application claims the benefit and priority of German Application No. DE102011103863.2, filed Jun. 9, 2011. The disclosure of the above application is incorporated herein by reference in its entirety.

### FIELD

The present invention relates to a method of slicing products, in particular food products.

### BACKGROUND

Different types of food slicing apparatus are known in the prior art. For example, so-called high-performance slicers are used to slice food products such as meat, sausage or cheese at a high cutting speed. In an endeavor to increase the cutting performance, with such apparatus a plurality of products can be fed simultaneously on parallel conveying tracks to a cutting plane in which at least one cutting blade moves. The cutting blade can e.g. be a circular knife revolving in planetary motion or a rotating scythe-like blade. Due to the parallel conveying tracks, it is possible to utilize a single cutting apparatus—having a correspondingly large cutting blade—for simultaneously cutting a plurality of products. To vary the thickness of the cut-off product slices for the individual conveying tracks during slicing and thus e.g. to keep constant the weight of individual sliced slices or of product portions comprising a plurality of slices, the conveying tracks can have mutually independent drives.

Slicers having a plurality of parallel conveying tracks can only be operated efficiently when the slicing of the products on all conveying tracks is ended substantially at the same time. Otherwise, namely, either those conveying tracks on which the slicing operation is prematurely ended must stand still in an unused manner or the product remainders on the remaining conveying tracks have to be discarded. Both ultimately impair the efficiency of the total plant. It is, however, difficult in practice to provide products having exactly the same product properties, e.g. product loaves or product bars of equal length or equal weight, so that apparatus of the named kind are frequently operated below their actual performance limits.

### SUMMARY

In accordance with the invention, a number of products exceeding the number of conveying tracks is provided, with at least one product parameter being determined for each product provided. Depending on the determined product parameters, a set of products corresponding to the number of conveying tracks is then selected from the provided products and the selected set of products is fed to the cutting plane on the conveying tracks.

In accordance with the invention, new products to be sliced are therefore not brought onto the conveying tracks simply in accordance with a random principle or in the order of their delivery, but rather specific combinations of products are selected from a previously collected larger number of products. Since the product parameter is known due to the parameter determination of all collected products, the selection can take place such that the products of a set are completely sliced at substantially the same time. Since therefore only “sensibly” combined product sets are output onto the conveying tracks, the efficiency in the slicing of the products can be increased since an unwanted slicing of product remainders on individual tracks is reduced. Furthermore, product processing devices, e.g. an automatic packaging machine, downstream of the slicing apparatus do not have to be especially designed for the separate processing of product slices or product slice portions on individual conveying tracks, whereby the affectivity of a so-called cutting line can be considerably increased.

Further developments of the invention are set forth in the dependent claims, in the description and in the enclosed drawings.

The set of products is preferably selected such that a deviation of the product parameters among the products of the selected set satisfies a predefined condition and is in particular minimal. For example, those products can be selected from the number of provided products which are equally long where possible, that is whose product length therefore has a deviation which is as small as possible. Since on a two-track product feed the two longest present products and the two shortest present products are e.g. each sliced together, the unwanted slicing of product remainders on a track can be minimized.

In accordance with an embodiment of the invention, the provided products are sorted with respect to a sorting criterion based on the product parameter before the selection of the set. The effort for the following selection procedure can thereby be reduced.

A plurality of product parameters can also be determined for every product provided, with the products being sorted with reference to a sorting criterion derived from the plurality of product parameters. It is, for example, possible to take both the product weight and the product length into account in sorting.

The sorted products can be fed set-wise sequentially to the cutting plane. This saves a complex search and selection process since the deviation of the product parameter within a selected set is automatically minimized when the products are sequentially removed from a sorted number of products.

In accordance with an embodiment of the invention, the weight of a product is determined as the product parameter. Since the slicing is usually carried out such that the weight of portions of sliced product slices or of individual slices is constant, a simultaneous ending of the slicing on all conveying tracks can thus be achieved in a number of significant application variants.

The provided products can be cooled in order thus also to avoid an impairment of the product consistency with longer buffering in a sorting or selection area and to satisfy the relevant regulations for the processing of food products.

The products can in particular be fed to a selection station upstream of the conveyor tracks for the provision. In dependence on the application, the selection station can be integrated into the slicing apparatus or can be upstream of it as a separate device. The determination of the product parameters and the selection of the set of products can in particular take place automatically in the selection station. This allows a particularly efficient slicing operation since new products to be sliced only have to be delivered and fed to the selection station. An operator of the plant does not have to monitor the order of the product supply.

The invention also relates to an apparatus for slicing products, in particular food products, having a product feed which is designed to feed a plurality of products simultaneously on parallel conveying tracks to a cutting plane in which at least one cutting blade moves, in particular in a rotating and/or revolving manner, and having a selection station which is designed to receive a number of products exceeding the number of conveying tracks, wherein the selection station includes a detection device for determining at least one product parameter for each received product and an output device which is designed to output a set of products to the product feed selected in dependence on the determined product parameters and corresponding to the number of conveying tracks. It can be achieved in this manner that only “sensibly” combined sets of products are output to the product feed by the parallel conveying tracks and thus a slicing of product remainders on individual tracks and a standstill on the other tracks is largely avoided.

In accordance with an embodiment, the selection station includes an ingoing conveyor, an outgoing conveyor associated with the output device, a plurality of product placement areas and a transfer apparatus, wherein the transfer apparatus is designed to transfer products from the ingoing conveyor to the product placement areas and from the product placement areas to the outgoing conveyor. The ingoing conveyor and the outgoing conveyor can be belt or band conveyors, for example. The products can be buffered on the product placement areas until they are transferred by the transfer apparatus, for example by means of a pusher or by means of a gripper arm, in sensible combinations from the corresponding product placement areas to the outgoing conveyor. The product placement areas can in particular be displaceable or adjustable and movable in another manner for this purpose.

In accordance with a further embodiment of the invention, the detection device is integrated into the ingoing conveyor. The desired product parameter of each ingoing product is thus determined automatically.

The detection device can in particular include an automated set of scales for determining the weight of each product. Alternatively or additionally, an optical scanning device can be provided to detect the size and/or the shape of the product. It is furthermore possible e.g. to determine the contour extent or the cross-sectional extent or the weight or density extent of the products. The detection device can include a product scanner for this purpose.

The invention furthermore relates to a selection station which is designed in accordance with the above-named principles.

### BRIEF DESCRIPTION OF THE DRAWINGS

The invention will be described in the following by way of example with reference to the drawings.

FIG. 1 is a simplified plan view of an apparatus in accordance with the invention for slicing food products;

FIG. 2 is a perspective view of a selection station which is associated with the apparatus in accordance with FIG. 1; and

FIG. 3 is a side view of the selection station in accordance with FIG. 2.

### DETAILED DESCRIPTION

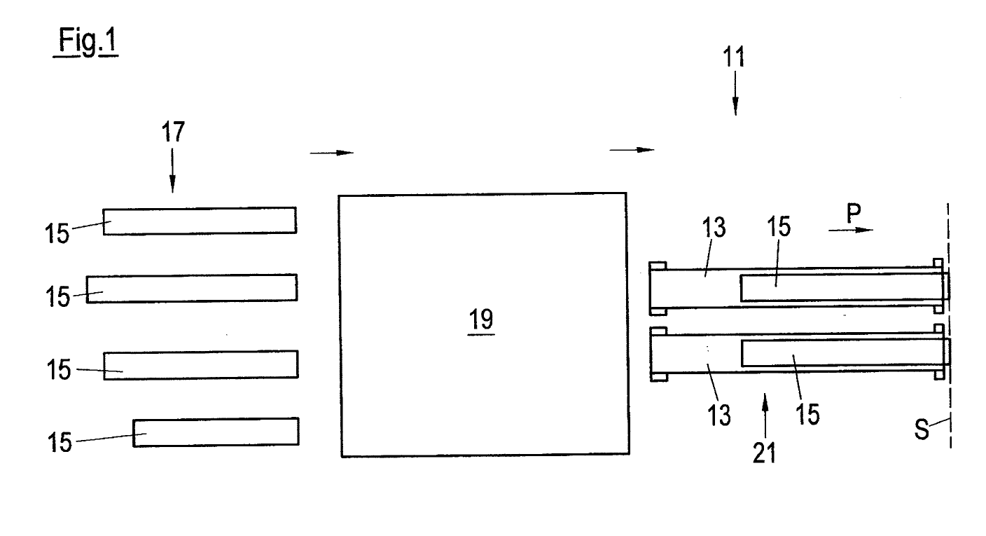

In accordance with FIG. 1, a cutting apparatus in accordance with the invention includes a product feed 11 having a plurality of belt conveyors 13 which are arranged next to one another, are aligned parallel to one another and feed products lying thereon simultaneously and in parallel along a product conveying direction P to a cutting plane S. In the cutting plane S, a cutting blade, not shown, moves which can in particular be a circular blade revolving in planetary motion or a rotating scythe-like blade. The cutting blade cuts through the two supplied products 15 at a constant cutting frequency in order thus to cut off product slices. The belt conveyors 13 can be driven independently of one another to vary the thickness of the product slices for observing a constant slice weight and/or portion weight during the slicing. Three or more parallel belt conveyors can also be provided in dependence on the blade size instead of the two belt conveyors 13.

New products 15 to be sliced are provided in an ingoing zone 17 of the slicing apparatus and are fed to a selection station 19 upstream of the belt conveyors 13. In the selection station 19, two respective products 15 are selected from a number of at least three products 15 for the two belt conveyors 13 and are supplied to them. The selection takes place on the basis of a product parameter which is previously determined within the selection station 19 for each provided product 15, as will be stated in more detail in the following.

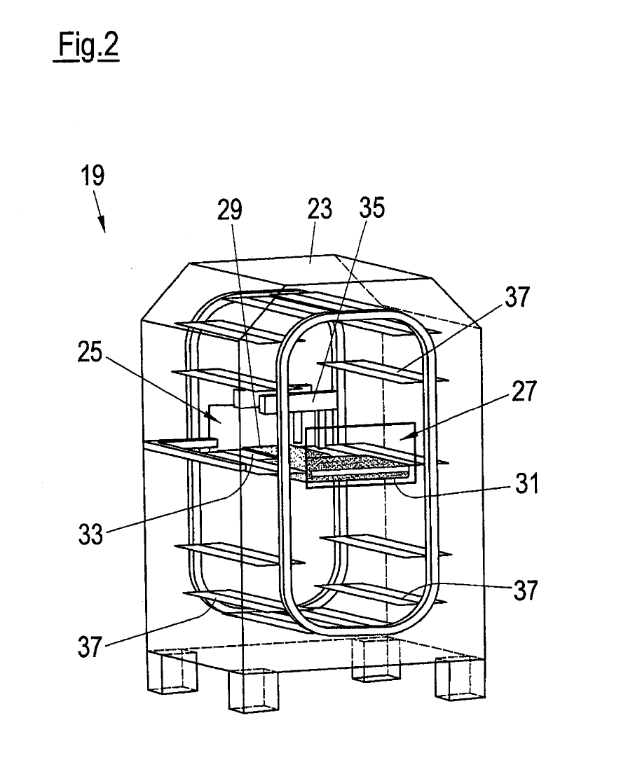

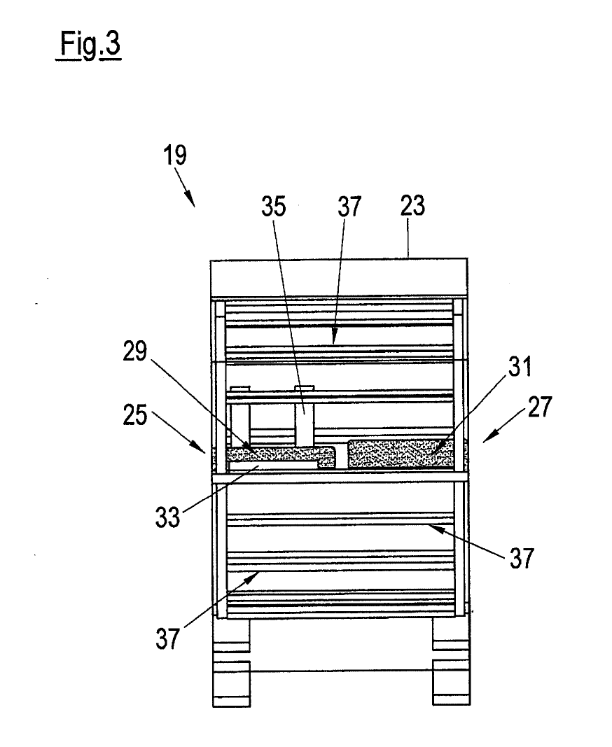

FIGS. 2 and 3 show the selection station 19 in detail. It includes a housing 23 with an ingoing opening 25 and an outgoing opening 27. An ingoing conveyor 29 and an outgoing conveyor 31, which are likewise both designed as belt conveyors, are arranged in the selection station 19 such that products 15 can be conveyed from the ingoing zone 17 (FIG. 1) into the selection station 19 and from the selection station 19 to the belt conveyors 13 (FIG. 1). An automatic set of scales 33 is integrated into the ingoing conveyor 29 so that the product weight is determined automatically for every product 15 ingoing into the selection station 29. The determined product weights for the products 15 which went in are buffered in an electronic control device, not shown.

An arrangement of displaceable product placement areas 37 extends around the ingoing conveyor 29 and the outgoing conveyor 31, said product placement areas being able to be moved alternately to the same level as the support surfaces of the ingoing conveyor 29 and of the outgoing conveyor 31. A transfer apparatus 35 in the form of a product pusher controlled by the control device is able to transfer products 15 from the ingoing conveyor 29 onto one of the product placement areas 37 and from one of the product placement areas 37 onto the outgoing conveyor 31. The ingoing products 15 are distributed over the present product placement areas 37 after the determination of the product weight by means of the scales 33 such that they are sorted by their product weight with respect to the arrangement of the product placement areas 37. The sorted products 15 are subsequently supplied pair-wise sequentially to the outgoing conveyor 31 in that the respective product placement areas 37 are moved onto a plane with the outgoing conveyor 31 and the transfer apparatus 35 transfers the two products 15 forming a selected set 21 (FIG. 1) from the corresponding product placement areas 37 onto the outgoing conveyor 31. Subsequently, the outgoing conveyor 31 transports the two products 15 through the outgoing opening 27 to the two belt conveyors 13 which feed the products 15 to the cutting plane S. The selected products 15 can be scanned optically, mechanically or acoustically before slicing to determine their contour extent and/or their structural extent.

In this manner, two products 15 always move onto the belt conveyors 13 as new products to be sliced which are approximately of equal weight, i.e. their product weight determined by weighing relative to the total amount of the present products differs as little as possible from one another. The product remainder which still remains on the belt conveyor 13 having the heavier product 15 after the slicing of the lighter product 15 is thus minimal.

In comparison with an unordered feed of the products 15 directly from the ingoing zone 17, a substantially higher product throughput thus results in a continuous slicing operation. Since the buffered products 15 optionally have to remain in the selection station 19 for a longer time period, the interior of the selection station 19 is cooled by a cooling apparatus, not shown.

The selection station 19 can, as in the embodiment shown, be a separate apparatus which is upstream of the product feed 11 of a slicer. The selection station 19 could, however, also be completely integrated into a slicer so that only newly delivered products 15 have to be placed on an ingoing placement area of the slicer and the subsequent sorting, selection and slicing process runs fully automatically.

### REFERENCE NUMERAL LIST

11 product feed
13 belt conveyor
15 product
17 ingoing zone
19 selection station
21 selected set
23 housing
25 ingoing opening
27 outgoing opening
29 ingoing conveyor
31 outgoing conveyor
33 scales
35 transfer apparatus
37 product placement area
S cutting plane
P product feed direction

What is claimed is:

1. A method of slicing products in which a plurality of products (15) are fed simultaneously on parallel conveying tracks (13) to a cutting plane (S) in which at least one cutting blade moves;
wherein a number of products (15) exceeding the number of conveying tracks (13) is provided;
at least one product parameter is determined for every provided product (15);
a set (21) of products (15) corresponding to the number of conveying tracks (13) is selected from the provided products (15) in dependence on the determined product parameters; and
the selected set (21) of products (15) is fed to the cutting plane (S) on the conveying tracks (13).

2. A method in accordance with claim 1, wherein the at least one cutting blade moves in a rotating and/or revolving manner.

3. A method in accordance with claim 1, wherein the set (21) of products (15) is selected such that a deviation of the product parameters among the products (15) of the selected set (21) satisfies a predefined condition.

4. A method in accordance with claim 3, wherein the deviation of the product parameters is minimal.

5. A method in accordance with claim 1, wherein the provided products (15) are sorted with reference to a sorting criterion based on the product parameter before the selection of the set (21).

6. A method in accordance with claim 1, wherein a plurality of product parameters are determined for every provided product (15) and the products (15) are sorted with reference to a sorting criterion derived from the plurality of product parameters.

7. A method in accordance with claim 5, wherein the sorted products (15) are fed set-wise sequentially to the cutting plane (S).

8. A method in accordance with claim 1, wherein the weight of a product (15) is determined as the product parameter.

9. A method in accordance with claim 1, wherein the provided products (15) are cooled.

10. A method in accordance with claim 1, wherein the products (15) are fed for providing to a selection station (19) interposed before the conveying tracks (13).

11. A method in accordance with claim 10, wherein the determination of the product parameters and the selection of the set (21) of products (15) takes place automatically in the selection station (19).

12. An apparatus for slicing products comprising
a product feed (11) which is designed to feed a plurality of products (15) simultaneously on parallel conveying tracks (13) to a cutting plane (S) in which at least one cutting blade moves; and
a selection station (19) which is designed to receive a number of products (15) exceeding the number of conveying tracks (13), wherein the selection station (19) includes a detection device (33) for determining at least one product parameter for each product (15) received and an output device (31) which is designed to output a set (21) of products (15) selected in dependence on the determined product parameters and corresponding to the number of conveying tracks (13) to the product feed (11).

13. An apparatus in accordance with claim 12, wherein said apparatus is adapted to carry out a method of slicing products in which the plurality of products (15) are fed simultaneously on the parallel conveying tracks (13) to the cutting plane (S) in which the at least one cutting blade moves.

14. An apparatus in accordance with claim 12, wherein the at least one cutting blade can be moved in a rotating and/or revolving manner.

15. An apparatus in accordance with claim 12, wherein the selection station (19) includes an ingoing conveyor (29), an outgoing conveyor (31) associated with the output device, a plurality of product placement areas (37) as well as a transfer apparatus (35), with the transfer apparatus (35) being designed to transfer products (15) from the ingoing conveyor (29) to the product placement areas (37) and from the product placement areas (37) to the outgoing conveyor (31).

16. An apparatus in accordance with claim 15, wherein the detection device (33) is integrated into the ingoing conveyor (29).

17. An apparatus in accordance with claim 12, wherein the detection device includes an automated set of scales (33) for determining the weight of the product (15).

18. A selection station (19) which is designed for carrying out a method of slicing products in which a plurality of products (15) are fed simultaneously on parallel conveying tracks (13) to a cutting plane (S) in which at least one cutting blade moves;
wherein a number of products (15) exceeding the number of conveying tracks (13) is provided;
at least one product parameter is determined for every provided product (15);
a set (21) of products (15) corresponding to the number of conveying tracks (13) is selected from the provided products (15) in dependence on the determined product parameters; and
the selected set (21) of products (15) is fed to the cutting plane (S) on the conveying tracks (13), wherein a detection device (33) for determining the product parameter; and
an output device (31) which is designed to output the selected set (21) of products (15) to the product feed (11) are provided.
